(19) United States
(12) Patent Application Publication
(10) Pub. No.: US 2008/0228869 A1
(43) Pub. Date: Sep. 18, 2008

(54) METHOD FOR ONLINE DISTRIBUTION OF DRM CONTENT

(75) Inventors: Andreas Kraft, Berlin (DE); Joerg Oppermann, Berlin (DE); Zhiyun Ren, Berlin (DE); Alexander Knabner, Neue Muehle (DE); Florian Koelln, Berlin (DE); Behrend Freese, Berlin (DE)

Correspondence Address: DARBY & DARBY P.C., P.O. BOX 770, Church Street Station, New York, NY, 10008-0770, US

(73) Assignee: Deutsche Telekom AG, Bonn (DE)

(21) Appl. No.: 12/041,805

(22) Filed: Mar. 4, 2008

(30) Foreign Application Priority Data
Mar. 14, 2007 (DE) 10 2007 013 014.9

(51) Int. Cl. G06F 15/16

(52) U.S. Cl. 709/203

(57) ABSTRACT

The invention relates to a method for online distribution of digital content that is protected by digital rights management (DRM). It makes it possible to disseminate such content via peer-to-peer networks, for instance, according to the bitstream principle. According to the invention, the file segments that are identical in terms of the distribution of the same content within different DRM files, are shared peer-to-peer among the terminal devices of the network subscribers under the control of a server, while all of the other specific components of a given DRM file, including the rights labels, are transmitted by a centralized site (2, 5), in other words, by a server (2) or by a terminal device (5) of a specific other network subscriber, to the terminal device (1) of a user who is requesting the content, whereby the file segments containing the content and the other file segments received from the centralized site (2, 5) are combined by client software running on the terminal device (1) that receives these file segments so as to form the DRM file that is to be stored on this terminal device (1) and, in case of another, later peer-to-peer transmission, they are separated from each other once again.

The invention relates to a method for online distribution of digital content that is protected by digital rights management (DRM). In particular, it relates to a method by means of which content protected in this manner can be distributed on the Internet via peer-to-peer (P2P) networks.

Fueled by the increasing availability of broadband transmission channels and the associated broadband connections of users of the Internet, the dissemination of digital content via the online modality or via the Internet has acquired enormous significance in recent years. This has especially affected the distribution of media content and software. In spite of the general availability of broadband technologies, however, an efficient dissemination of media content, particularly in view of the large data volume associated with this, places a considerable burden on the technical systems used for this purpose. This is especially the case when popular media content, for example, a new movie, is requested by a very large number of users within a short period of time. This causes bottlenecks in the available transmission broadband or else the individual servers of distribution systems having a centralized structure reach their technical limits. From the perspective of the user requesting that particular content, this leads to considerable loss in performance or to long, download times, and in extreme cases, can even result in a crash of the server or servers of the provider.

This is one of the reasons why technologies were developed to distribute the digital content in question by means of decentralized systems. Here, the requisite transmission broadband is divided among a plurality of connections so to speak and/or resources such as the necessary storage capacities or computing power are made available by a larger number of computers which then divide up the computing load associated with the distribution of the content. These computers then form so-called peer-to-peer networks that generally consist of a loose association of computers that is only of a temporary nature. Various solution principles have become known for purposes of distributing digital content via peer-to-peer networks. Among others, the so-called bitstream or BitTorrent principle has acquired great significance. In this context, the content in question is no longer acquired from a central server by the requesting users but rather the content is shared among them.

This sharing is set up in such a way that the computer or another Internet-capable device of a user acquiring the digital content—perhaps already after only part of the content in question has been received—immediately makes this part of the content available to other users via an upload so that it can be downloaded. The data sharing here is usually organized by software running on a server, a so-called tracker. This tracker collects all of the information indicating from which of the decentralized computers (peers) the particular files or parts thereof can be obtained at a given point in time. En order to identify a particular content, a hash value is formed via meta information that refers to this content or via parts thereof, and by means of this hash value, the tracker provides the information about the sources (peers) that are currently available for a download of segments of the desired content. The parts or segments belonging to a content or to a file containing said content are verified by a comparison to a given checksum. A comparable method is described, for example, in German patent application DE 10 2005 010 131 A1.

The use of peer-to-peer networks, however, has also led to a situation where the principle explained above or comparable mechanisms allow media content and software to sometimes be distributed in violation of copyrights or proprietary rights. Therefore, in order to be able to distribute copyrighted content via electronic media, especially via the Internet, distributors have created so-called digital rights management systems. Here, the digital content in question is encrypted by an entity entitled to utilize the rights (rights owner) and their use is coupled to a license, whereby rights labels are linked to the content and they contain information about the rights owner and/or they stipulate the conditions under which, that is to say, in what way, the content can be used by a buyer. Once the license has been purchased, which the user acquires in conjunction with the lawful purchase of the content, the key associated with the license allows the user to decrypt the content and to use it in accordance with the conditions stipulated in the rights labels and/or in the license. Since the rights labels, however, can be configured very differently for various users who purchase content independently of each other, the linking of these rights labels to the content in a shared DRM file means that segments of such a file—such as are formed, for instance, when the bitstream principle is used and when the distribution takes place via a peer-to-peer network—can no longer be compared to each other in terms of their checksums (which usually are likewise ascertained through the formation of a hash value). Therefore, according to the state of the art, a peer-to-peer distribution of DRM-protected content is not possible, at least not employing the bitstream principle.

U.S. pat. appl. 2004/0030651 A1 describes a method with which copyrighted content is transmitted peer-to-peer. This is made possible in that, every time, the entire content is transmitted by a network subscriber who possesses this content to the terminal device of a network subscriber who is requesting that content. According to this method, it is ensured that the particular receiver of the content has to make a payment, part of which goes as a reward to the particular sender of the content. The drawback of this is that the upload rate, that is to say, the transmission rate of the terminal device, of a regular peer-to-peer subscriber who is sending the content is considerably slower than that of the professional servers, resulting in very long transmission times for voluminous content such as, for example, movies.

The objective of the invention is to put forward a solution that allows DRM-protected content to be conveniently disseminated via peer-to-peer networks, preferably also employing technologies such as the bitstream principle.

This objective is achieved by a method having the features of the main claim. Advantageous embodiments and refinements of the invention are put forward in the subordinate claims.

According to the method being proposed to achieve the objective of online distribution of digitized content that is subject to digital rights management for its use, a rights label containing said content and information about the rights owner and/or the conditions of use of this content within the scope of the digital rights management are transmitted to a terminal device of a user requesting said content via a network comprising a plurality of network-capable terminal devices and at least one server. The actual content is transmitted in encrypted form. The content and the associated rights labels are stored for later use of the content in the terminal device of the requesting user in the form of a DRM file that contains at least the encrypted content and the rights labels and that cannot be manipulated (by the user). In this context, the content in question can be used later on either directly with the network-capable terminal device that has stored said content or else with another device of the user configured for this purpose. In the latter case, it is conceivable, for example, for the DRM file stored on the receiving terminal device to be transmitted via a Bluetooth interface or another interface in order to be used on another device of the user such as, for instance, a multimedia-capable cell phone or mobile radio.

The above-mentioned rights labels can be configured in many different ways. Their content and format depend on the DRM method used by the rights owner in question. As already mentioned, the rights labels can contain various information about the rights owner and also information that stipulates in what way and under what conditions a given content can be used. However, the latter, that is to say, the conditions of use, can also be jointly stipulated by parts of the rights labels and by the license that has to be purchased for the use of the content. In this sense, the term “license” on the one hand, has a legal meaning but, on the other hand, it also designates and contains purely technical constituents such as the keys for decrypting the content and, if applicable, technical means that interact with the rights labels. These technical means are, for instance, control labels that, when a given content is used under the applicable license, technically directly influence or, optionally, also restrict, the possibilities of this use. In individual cases, once the license has been activated on a device for the use of a given content, the technical features of the license can also be combined with the rights labels in such a manner that the original rights labels are modified by the activated license and/or the rights labels and the license can no longer be distinguished from each other as far as the file is concerned so that they should then be jointly considered as rights labels as put forward in the method described.

Each DRM file according to the method encompasses at least one file segment comprising at least a part of the content, whereby optionally, content having a low data volume can also be completely contained in just one such file segment. Each such file segment containing the content or a part thereof is also identical to the file segments of other DRM files according to the method that contain the same part of the content, provided that the appertaining content contained in the file segments was encrypted by the same rights owner. In contrast, the other components of the DRM files, thus especially the rights labels and conceivably other file components of different DRM files having an otherwise identical content, can and, as a rule, will differ from each other.

According to the invention, the method is configured in such a way that, regarding the distribution of the same content within different DRM files, the identical file segments are each shared peer-to-peer among the terminal devices of the network subscribers under the control of a server. The other components of a DRM file that differ from each other, especially the rights labels, in contrast, are transmitted by a centralized site, in other words, by a terminal device of a given network subscriber or by a server of the network, to the terminal device of a user who is requesting a given content. Moreover, according to the invention, the file segments containing the content and the other file segments received from the centralized site are combined by client software running on the terminal device that receives these file segments so as to form the DRM file that is to be stored on this terminal device. Moreover—in case of another, later peer-to-peer transmission of file segments containing the content to a terminal device of another user who is requesting the content in question, whereby the original receiver of the content functions as the provider or uploader—the file segments containing the content and the other file components containing especially the rights labels are separated from each other once again by this client software for purposes of this transmission. The invention is thus based on the idea of disseminating the identical parts of DRM files holding the same content by means of known peer-to-peer techniques via the network but, in contrast, of making available for retrieval at a centralized site the non-constant parts of the DRM files—that is to say, the parts that vary from one distribution procedure to the next such as, for instance, especially the rights labels. This centralized site can be the terminal device of a specific network subscriber or the server of a content provider.

According to a preferred embodiment of the invention, the method is configured in such a way that, immediately after a terminal device of a requesting user has received file segments containing the content, said terminal device makes these file segments once again available for transmission to other terminal devices requesting the same content. This corresponds to the procedure of known peer-to-peer methods such as, for instance, the bitstream method.

Particularly in terms of the latter peer-to-peer transmission principle, the method according to an advantageous embodiment is configured in such a manner that the peer-to-peer transmission of the file segments with the content is controlled by software running on a server of the network, a process in which each file segment of a content can be identified on the basis of a checksum and an association can be made to this content by means of a hash value that identifies the content in its entirety and that is formed via a first meta information. This first meta information contains information such as the checksums of the file segments belonging to the content, the name and size of the file consisting of these file segments of the content in question, as well as the network address of the peer-to-peer distribution using the hash value and the server that controls the checksums of the file segments. Here, a terminal device requesting the content uses the client software running on it to extract the above-mentioned first meta information from a second meta information which the terminal device requesting the content had previously acquired from a server or terminal device of a network subscriber who provides or recommends the content. This second meta information preferably contains information about the type of content. Optionally, it can also contain a content ID or information for deriving an identifier that allows the later purchase of a license as well as of a key associated with it that allows the decryption of the content. According to another variant of this embodiment, the rights labels can also be a constituent of this second meta information while, according to another variant, the rights labels can be obtained from a server or a terminal device of the network by using the above-mentioned hash value that identifies the content.

According to an advantageous refinement of the method according to the invention, the above-mentioned second meta information can also contain general information that relates to the type of content and that is intended for the user. This can be, for example, the title of a music album, a list of titles or information about the performer. If the content is, for instance, a movie, said meta information naturally can also contain information about the actors and it can also contain additional information that is of interest to the buyer or buyers of the content.

As already explained extensively above, the file segments containing the actual content are transmitted peer-to-peer, that is to say, a user requesting the content in question receives it in the form of a plurality of file segments, possibly from other completely different users of a network that serves for the inventive distribution of content. The items of information that differ from each other, in contrast, are provided by a centralized, optionally previously known site. The latter especially refers to the rights labels. Various method variants are conceivable for transmitting the rights labels.

According to a method variant provided, the method takes place as follows:
a) using a network-capable terminal device, a user selects the desired content from a server of the network that provides this content. In conjunction with this or already before that, a special client software is started on the terminal device of the user;
b) on the basis of the content selection made by the user, the server cited under a) transmits to the terminal device of the user a file containing the first meta information needed for downloading the content in question as well as the second meta information needed for the rights management, but not containing the rights labels;
c) the first meta information needed for downloading the content and containing the checksums of the file segments belonging to the content, the name and the size of the file consisting of the file segments of the content in question and the network address of the server that controls the peer-to-peer distribution is extracted from the file by the client software of the terminal device of the user receiving the file with the meta information, after which the hash value that identifies the content is formed on the basis of this first meta information or of parts thereof;
d) the hash value is transmitted by the client software of the terminal device requesting the content to the server cited under c) which controls the peer-to-peer distribution using the hash value and the checksums of the file segments with the network address contained in the first meta information;
e) under the control of the server that receives the hash value, the content in the form of file segments that are transmitted by terminal devices of other network subscribers directly to the terminal device of the user requesting the content is transmitted peer-to-peer. After the content has been completely received by this terminal device, the rights labels are acquired from the server that provides the content under the control of the client software running on the terminal device and by means of the hash value formed from the first meta information. The purchase of the license that allows the use of the content with the appertaining key needed to decrypt the content is then a conventional purchasing procedure. Here, using a content ID contained in the second meta information or an identifier derived from this meta information, the license can be purchased from any server that allows this, preferably, from a server that is maintained by a special shop.

With the above-mentioned first variant of the method, the network subscriber or the rights owner who originally made the content available for distribution does not have to be identical either to the operator of the server that provides this content or to the operator of the shop for the purchase of the license, whereby, however, the selection of the content and of the shop for the purchase of the license can optionally also be implemented on a shared server. The network subscriber or the rights owner who originally made content available can be a network subscriber who, optionally in conjunction with another content, functions as the user of this other content which, in this case, he has acquired via the network. In this context, the method is configured in such a way that the client software running on the network-capable terminal device of a network subscriber placing a content that is being placed onto the network for the first time transmits the content, together with the rights labels generated by this software, to the server providing the content. The network subscriber who is providing the content can be identified on the basis of the rights labels and, if applicable, can be rewarded or recognized for his participation in the distribution of content.

According to a second method variant, a network subscriber is alerted to a certain content by a recommendation made by another network subscriber. For this purpose, the terminal device of the subscriber making the recommendation transmits a file consisting once again of the first and second meta information to the terminal device of the subscriber receiving the recommendation. In this case, however, an integral part of this file, to put it more precisely, of the second meta information, is also the rights labels for the content in question. The acquisition of the actual content by the network subscriber receiving the recommendation then takes place in a manner analogous to the first method variant. This means that the first meta information that serves for the management of the peer-to-peer distribution of the actual content is extracted by the client software running on his terminal device from the first file obtained from the other network subscriber within the scope of the recommendation, and a hash value is then formed on the basis of this first meta information. This hash value is then transmitted to the server that controls the peer-to-peer distribution, the address of said server, in turn, being contained in the meta information. Under the control of the server, the actual content is then distributed peer-to-peer, whereby in this case, the rights labels are already present at the network subscriber who is requesting the content and they are stored together with the received content in the form of a DRM file. Now, after the download of the content has been completed, all that the user has to do is to purchase the license with the key for the use of the content. In this case, within the scope of this purchase, information contained in the second meta information about the network subscriber who has recommended the content is transmitted to the shop that sells the license, so that the subscriber who made the recommendation can be rewarded for his participation in the distribution or marketing of the content. As far as rewarding network subscribers who support the distribution is concerned, however, another variant is possible, irrespective of whether the rights labels are made available by a server according to the first method variant, or by another network subscriber according to the second variant. Here, in conjunction with the acquisition of content by a user who is requesting said content, the server that controls the peer-to-peer transmission records how many of the file segments containing parts of the content are made available—through the modality of an upload—by individual network subscribers so that they can be downloaded by subscribers requesting the content. The network subscriber with the largest upload volume can then, in turn, be commensurately rewarded.

It can be gleaned from the explanations above that the file segments that contain the content and that are identical for identical content parts have to be differentiated from the other components of the DRM files so that they can be separated from the variable file parts. Different embodiments of the method according to the invention are also conceivable in this context. Insofar as the format of the DRM files is known, the file segments that contain the content and that are identical for the same content can be located within the DRM file on the basis of the format properties of the DRM format in question, and/or on the basis of information immanent to this format, and can then be extracted from said DRM file. According to an embodiment that is thus possible, the individual file components—in other words, the variable file components, on the one hand, and the same file components (file segments), on the other hands in the case of an identical content—have a label that introduces the appertaining file section, or else they are blocks of a fixed length. Moreover, the second meta information can contain references to the file parts containing the content, and the appertaining file parts or file segments with the content can be located within the DRM file on the basis of these references. However, it is likewise conceivable that a reference checklist with the checksums of the file segments containing the content is stored for comparison purposes on the server that controls the peer-to-peer transmission of the file segments containing the content. In this context, the file segments with the content, which are contained in a given DRM file, can, by means of a comparison to the reference checklist of the server, be extracted from the DRM file by the client software that is running on the terminal device of a network subscriber. The use of the method for various, initially unknown DRM specifications can also be effectuated in that a reference file for each of the specifications is stored on the server providing the content. A DRM file whose specification is unknown and that is to be processed by the client software of the terminal device of a network subscriber can be compared to the reference files of the server by means of a so-called longest-common-substring algorithm, and at first, the specification of the DRM file present is ascertained and subsequently the file segments containing the content are extracted from said file.

In addition to the method presented above, another subject matter of the invention is a computer program product for the execution of said method. This product is a data carrier with client software stored on it, whereby this software makes it possible to receive parts of file segments containing this content via a peer-to-peer network, and to receive rights labels containing information about the rights owner and/or stipulating the conditions for use of the content in question for purposes of downloading digitized content that is subject to a digital rights management for its use, from a centralized site of the network, and it also makes it possible to combine the above-mentioned file segments with the content parts and the rights labels (preferably in a manipulation-proof manner) to form a DRM file, if this client software is loaded in the main memory of a network-capable terminal device having a program-processing unit.

This computer program product according to the invention is refined in that the client software stored on the data carrier allows the proper use of the content such as, for instance, playing an MP3 file—insofar as a license with an appertaining key for the use of the content allows its decryption. Irrespective of whether the computer program product according to the invention is also configured for the actual use of the content or only for downloading it, the computer program product can be further refined in that the software stored on the data carrier makes it possible to separate the parts of a DRM file containing the content from the rights labels, and to make the file segments containing the content available for an upload within the scope of a peer-to-peer data transmission, as well as, optionally, to load the rights labels onto a server of the network or to transfer them to another network subscriber.

The invention will be described once again in greater detail below with reference to an embodiment and to the drawings. The accompanying drawings show the following:

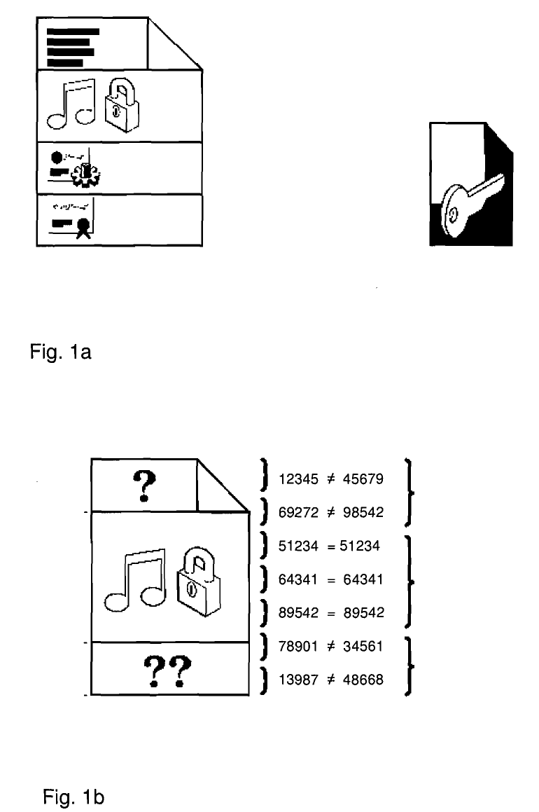

FIG. 1a: a rough diagram of a possible structure of a DRM file;

FIG. 1b: the DRM file according to FIG. 1a, with checksums formed by means of segments of the file;

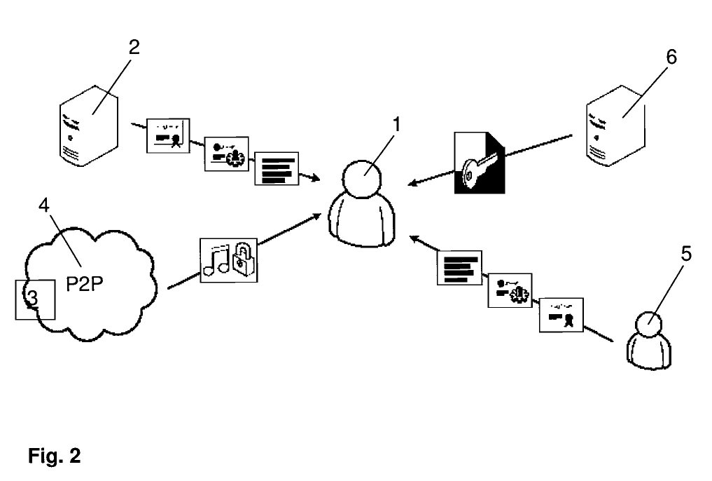

FIG. 2: a diagram to illustrate the transmission paths according to the invention;

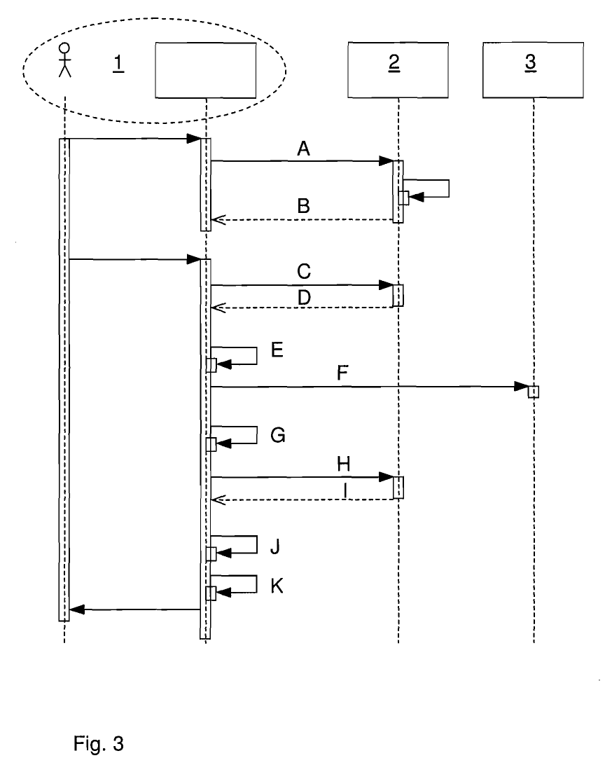

FIG. 3: a flow diagram for the purchase or download of content;

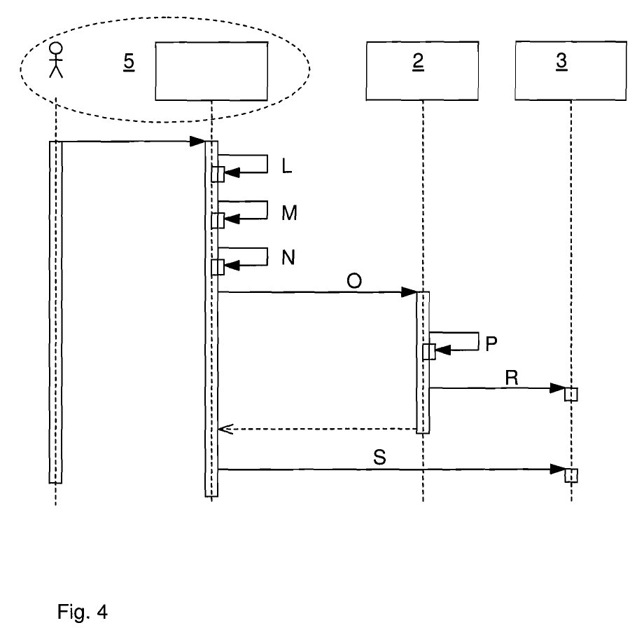

FIG. 4: a flow diagram for the provision of content to be downloaded by another network subscriber.

FIG. 1a schematically shows a possible structure of a DRM file according to the method. This file consists of a first block containing, for example, information about the type of content it contains, of a second block containing the content, of a third block containing rights labels and of a fourth block containing an electronic signature of the content issuer. The first block containing the information about the content is normally also referred to as meta information whereby, in conjunction with the explanation of the embodiment and in the context of the invention, this first block, in other words, the actual meta information, the third block containing the rights labels and the fourth block containing the signature together should be referred to as meta information. Together, the above-mentioned blocks constitute the information that is referred to in the claims and in the explanations above as the second meta information needed for the rights management. This second meta information includes the content in the structure of the DRM file shown by way of an example.

In FIG. 1b, checksums are formed by means of segments of a defined size of the DRM file depicted in FIG. 1a. These checksums have been formed by means of the DRM file that is currently to be transmitted as well as by means of another DRM file having the identical content, for instance, a reference file. Here, it can be seen that the file segments containing the actual content also have the same checksums for an identical content. Precisely these file segments are transmitted peer-to-peer (P2P), with the method according to the invention, while the other file components, that is to say especially the second meta information with the rights labels, differ from each other in terms of their checksums, and are transmitted from the centralized site 2, 5 to the terminal device 1 of a user requesting the content.

The above-mentioned transmission paths are once again depicted in FIG. 2. Here, the symbols corresponding to those of FIG. 1a show that the user 1 or his terminal device acquires the encrypted content via the peer-to-peer (P2P) network, while he receives the parts of second meta information, especially the rights labels, either from a server 3 that provides the content in question or from another user 5 who has recommended the content to him. The content transmitted peer-to-peer as well as the second meta information are again stored—as a shared DRM file having a structure of the kind shown by way of an example in FIG. 1a—on the terminal device 1 of the user by the client software processed on said device. By means of, for instance, a content ID contained in the second meta information or by means of another identifier that can be derived from it, the user can purchase from a shop a license and an associated key that allows him to decrypt the received content and to use it. Here, however, the purchase of the license and of the key is basically completely independent of the actual method upon which the invention is based. According to the example, the purchase is made online from a server or shop 5. However, this can also be done through other modalities. The server 2 shown in the figure can be physically a server through which, on the one hand, content is provided and, on the one hand, on which software is running that controls the peer-to-peer download of the file segments of content to be transmitted using the hash value formed by the first meta information and the checksums of the file segments containing the content. Optionally, however, as in the example, the server 2 providing the content and the server 3 that controls its peer-to-peer distribution can be physically separated, whereby then the server 3 that controls the peer-to-peer transmission is located or arranged somewhere in the network 4 symbolized as P2P. The peer-to-peer distribution of the content preferably takes place according to the bitstream or BitTorrent method mentioned several times above.

FIG. 3 shows by way of an example a flow diagram for the download of content by means of the method according to the invention, employing the above-mentioned bitstream principle. The content is transmitted via a network 4 which encompasses, among other things, a terminal device 1 of a user requesting the content, client software running on said device, a server 2 that provides the content, and a server 3 that controls the peer-to-peer distribution of the content, whereby the latter server 3, as already mentioned, can also be one and the same as the server 2 that provides the content. The latter should also be referred to as MediaNet server 2 in the explanation of the embodiment, while the server 3 or the server component with the software that controls the peer-to-peer transmission should be referred to as the tracker.

By means of a network-capable terminal device 1 and of the client software running on it, into which a browser is preferably incorporated as a plug-in, a user initiates a search for content of interest to him on the MediaNet server 2 by submitting a request (A). If the user finds something on the results list (B) sent to him by the MediaNet server 2 in response to the request (A), the user selects (C) the desired content from the MediaNet server 2. In response to this, the MediaNet server 2 transmits (D) to the user's terminal device 1 a file consisting of first meta information needed for the peer-to-peer transmission of the content, as well as a second file consisting of meta information needed for the rights management. The client software running on the terminal device 1 of the user extracts (E) from this file the first meta information that allows acquisition of the actual content according to the above-mentioned bitstream principle. A hash value derived from this is transmitted (F) to the tracker. Under the control of the tracker 3—where the information converges about which of the terminal devices of network subscribers currently present in the network 4 have; individual file segments available for transmission—the file segments (G) that form the content are transmitted peer-to-peer to the terminal device 1 of the user requesting the content. Once the file segments have been downloaded, the client software running on this terminal device checks whether rights labels relating to the content in question are already present on the terminal device 1 of the user. This could be the case, for instance, if these rights labels had already been transmitted to him by another network subscriber 5 within the scope of a recommendation by this other network subscriber 5.

According to the example explained above, however, the terminal device 1—or the client software running on it—of the user requesting the content does not yet have access to the appertaining rights labels. Consequently, using the hash value formed from the first meta information at the beginning of the process, the software requests (H) said rights labels from the MediaNet server 2. The rights labels are acquired (I) via the terminal device 1 of the user and saved (J) by the client software running on said device as a DRM file together with the file segments containing the content that had been previously transmitted peer-to-peer. As long as the user then purchases a license and thus a key in any desired manner, preferably likewise online from a server 6, the user can use the content after its decryption according to the stipulations of the rights label. Provided that the terminal device 1 of the user remains online and provided that the user is in agreement with this, the content received by the user continues to be available for transmission to other network subscribers who request the content (K).

FIG. 4 shows a flow diagram for the provision of content by a network subscriber 5. The client software running on the terminal device 5 of the network subscriber or user in question generates (M) the first meta information needed for the peer-to-peer transmission of the content selected (L) by the network subscriber 5. This information is then combined (N) with the second meta information, likewise generated by the client software, containing the rights labels, to form a file. The file thus created is transmitted (O) to the MediaNet server 2. Once the MediaNet server 2 has ascertained (P) that the content is a content that is being placed for the first time onto the network 4, it announces (R) this fact while transmitting to the tracker 3 the first meta information needed for the peer-to-peer transmission. Afterwards, a connection is established between the tracker 3 and the terminal device 5 that is making the content available, and the distribution is initiated (S) according to the bitstream principle. Once the terminal device 1 of another user of the terminal device 5 that originally placed the content has received a first file segment of the content, the terminal device 1 of this user immediately makes this file segment available for download by other users, for which purpose the terminal device 1 of the second user transmits to the tracker 3 the appropriate information about the receipt of the file segment, after which the tracker controls the continued peer-to-peer distribution of the content.

1. A method for online distribution of digitized content that is subject to digital rights management for its use, according to which the appertaining encrypted content—hereinafter referred to as content—and specific rights labels of a rights owner, which contain information about the rights owner and/or the conditions of use of this content are transmitted via a network (4) comprising a plurality of network-capable terminal devices and at least one server (2, 3) to a terminal device (1) of a user requesting said content, where, for the later use of the content, they are stored with the receiving terminal device (1) or with another device configured for this purpose, in the form of a DRM file that contains at least the appertaining encrypted content and the rights labels, whereby each DRM file encompasses at least one file segment comprising at least a part of the content and each such file segment is identical to the same part of other DRM files according to the method that contain the same part of the content, provided that the appertaining content was encrypted by the same rights owner, characterized in that, regarding the distribution of the same content within different DRM files the identical file segments are each shared peer-to-peer among the terminal devices of the network subscribers under the control of a server, while all of the other specific components of a given DMA file, including the rights labels, are transmitted by a centralized site (2, 5), that is to say, by a server (2) or by a terminal device (5) of a specific other network subscriber, to the terminal device (1) of a user who is requesting the content, whereby the file segments containing the content and the other file segments received from the centralized site (2, 5) are combined by client software running on the terminal device (1) that receives these file segments so as to form the DRM file that is to be stored on this terminal device (1) and, in case of another, later peer-to-peer transmission of file segments containing the content to a terminal device of another user who is requesting the content in question, and said file segments containing the content and said other file segments are separated once again from each other by this client software for purposes of this transmission.

2-19. (canceled)
